(19) United States
(12) Patent Application Publication
(10) Pub. No.: US 2014/0046692 A1
(43) Pub. Date: Feb. 13, 2014

(54) WEB-BASED REAL-TIME PATIENT TRACKING AND REFERRAL MANAGEMENT SYSTEMS AND METHODS

(71) Applicants: Ilien J. Minter, Poway, CA (US); Brian J. Minter, Ramona, CA (US)

(72) Inventors: Ilien J. Minter, Poway, CA (US); Brian J. Minter, Ramona, CA (US)

(21) Appl. No.: 13/759,023

(22) Filed: Feb. 4, 2013

Related U.S. Application Data
(60) Provisional application No. 61/594,029, filed on Feb. 2, 2012.

(51) Int. Cl. G06F 19/00

(52) U.S. Cl. CPC G06F 19/3425
USPC 705/3

(57) ABSTRACT

For those experienced with medical and dental practice management, it is clear that there exists a substantial need for better communication across medical/dental offices as pertains directly to mutual patient treatment and care. The specification herein provides a straightforward way to better serve the patient and improve practice efficiency through the design of a single, centralized system for which to manage all patient referrals in their practice. More specifically the present disclosure comprises a simple, thorough, and straightforward answer to this problem. The methods and management systems are easy to use, reliable, and created by medical/dental personnel for medical/dental personnel to provide cost savings, increase practice production, and most importantly, improve the patient experience.

### CROSS REFERENCE TO RELATED APPLICATION(S)

This application claims the benefit of priority under 35 U.S.C.§119(e) of U.S. Ser. No. 61/594,029 filed Feb. 2, 2012 the entire content is incorporated herein by reference.

### BACKGROUND OF THE INVENTION

1. Field of the Invention

The invention relates generally to a web-based patient referral management program and accompanying services and more specifically, to a web-based method of sharing and managing mutual patient information and tracking treatment progress of a patient by all attending doctors, dentists and laboratories in real-time.

2. Background Information

Currently a significant communication breakdown across general and dental specialist providers (endodontists, orthodontists, etc.) exists in the form of limited shared mutual patient treatment information. At present, most dental practices use differing practice management software specific to their particular needs and as such the method of sharing such information is restricted to phone, fax, email, postal mail or patient delivery. Without a centralized process with which to access, exchange and update patient information, documentation is often lost, misinterpreted, of poor quality, and vulnerable to unauthorized alteration.

Thus, there exists a significant need for a more effective method of sharing mutual patient information and tracking treatment progress across all attending doctors, dentists, laboratories and related healthcare providers. This communication barrier across attending doctors, dentists and laboratories can best be remedied by the sharing in real-time of patient information through a web-based program (website) and corresponding application (“app”).

### SUMMARY OF THE INVENTION

The present invention was created by dental personnel for medical and dental personnel to use and comprises of a web-based program as well as an application (“app”) to create a referral and records management system that allows multiple attending doctors/dentists/medical personnel and staff to share access to and update mutual patient information as desired. Embodiments of the Mutual Patient program provide for a common location for such information to be referenced and stored to remedy the issue of conflicting or non-interchangeable practice management software. Embodiments utilize several layers of security applications to ensure all information uploaded into the system is fully protected and extensively encrypted. Furthermore, all processes associated with the present invention are in accordance with HIPAA guidelines. Additional embodiments cover the utilization and protection of uploading information into the application comprising but not limited to: referral letters, correspondence, X-Rays, treatment progress and updates, digital photos, medical release forms and all other relevant information that will help improve the patient experience and allow the Doctor(s) to chronicle treatment.

The present medical/dental multi-practice management docking system contemplated is an online resource that streamlines all stages of a patient's treatment (such as a dental patient) from beginning to end. The primary function is to consolidate, categorize and archive all related medical/dental patient information at each stage of treatment—from referral letter to diagnosis and procedural history. Additional supporting information such as radiographs and digital photos are also included.

Whereas embodiments of the present invention may be generally related to all healthcare records and personnel, specific examples provided herein are for use by general dentists and specialists, as well as dental laboratories wherein real-time access to all related patient treatment information is allowed between users. This, in turn, eliminates the need for email, postal mail, and telephone/fax machine correspondence.

Embodiments of the present medical/dental patient management invention generally relate to a centralized, collaborative platform that allows dentists/doctors/healthcare assistants and professionals to jointly manage mutual patient treatment in a real-time, user-friendly format. In certain embodiments of the present invention created for the dental industry, embodiments may include: a) A Real time, Multi-User Interface—wherein the user may access treatment updates, progress notes, radiographs, referral letters and the like; additionally, the user may manage patient cases remotely and in real time, while on travel or away from the office; b) A technical advantage wherein the user may have the ability to share digital imaging and case information with all attending doctors or independent labs (such as a dental lab) and thus is able to thoroughly oversee the patient treatment management process from beginning to end; c) An increase in patient referrals may occur by making the users practice information available to other referring doctors in their area; d) further embodiments include a detailed reporting & analysis feature which may provide a detailed analysis on referring doctors, case acceptance statistics, treatment timelines, and the like; e) and yet further additional embodiments relate to an improved productivity and the end of missing, illegible, and incomplete treatment information.

### BRIEF DESCRIPTION OF THE DRAWINGS

FIG. 1 shows a depiction of a use of a referral management cycle contemplated in the present invention wherein the system is used in the dental industry.

FIG. 2 shows a depiction of an exemplary screenshot and description of a digital patient chart.

### DETAILED DESCRIPTION OF THE INVENTION

The present invention is based on both a website and application (“app”) medical/dental patient treatment management system which eliminates the need for written, email, postal mail and fax machine correspondence from one medical/dental healthcare professional to another by storing all patient treatment information in a single centralized location. Additional embodiments include allowing the access to all information from a single centralized location, while allowing the actual information to be stored securely in a digital format that is backed up and maintained securely, even in the event of physical theft, or elements such as water and fire or other disasters associated with physical files.

The medical/dental patient treatment management system embodied in the present invention is an online resource that streamlines all stages of a patient's treatment from beginning to end. A primary function of the medical/dental patient treatment management system is to consolidate all treatment documentation at each stage—from referral letter and initial diagnosis to procedural history, prognosis and post-operative reporting. Additional embodiments of the present invention include the ability to review information such as but not limited to radiographs, digital photos, and medical/dental consultation forms.

An embodied medical/dental patient treatment management system available for use by medical doctors, general dentists and specialists as well as medical/dental labs allows for real time access to all related patient treatment information. This, in turn, eliminates the need for email and fax machine correspondence and lost labor (employee time) and materials (postage fees, telephone costs) expenses.

Some of the other embodied benefits for a medical professional using an embodied medical/dental patient treatment management system may include:

i) Increased turnaround time for laboratory case submissions and results

ii) Shared access to digital information on a “mutual” patient case

iii) Real time updates to all submissions and changes

iv) Web-based access to shared and centralized patient information (website and “app”)

v) Streamlining of collaborative treatment processes

vi) Reports and Analytics on referral and related statistics as requested by user

vii) Increased visibility to referring doctors through ad space and making contact information “viewable” to referring medical/dental providers and personnel.

Additional embodiments of the medical/dental patient treatment management system have features which saves doctor/dental office time by:

i) Ensuring accuracy of information (no more re-sends, etc.)

ii) Centralizing all patient treatment information (nothing lost, in poor quality or illegible)

iii) Allowing Real Time information updates and changes

iv) Keeping all parties (Generalists, Specialists, Labs and Patients) “in the loop”—no miscommunication, labor and material costs in locating missing information

v) Ensures patient privacy (SSL encrypted site; password protected; user-acknowledged security disclaimer)

vi) Privacy for the patient AND the doctor/dentist (no public access without patient consent)

vii) Less chance of litigation (everything documented, chronicled)

Additional embodiments of the present medical/dental patient treatment management system insure that referrals by attending physicians/dentists are confidential. For example, an orthodontist cannot view whether referrals for the same patient were also sent to other orthodontists.

Yet additional embodiments of the contemplated medical/dental patient treatment management system include the capability of handling cross-functional treatment (multiple attending doctors/dentists/specialties, etc.), and the ability to create customized referral forms as a template for each referral to that specific office. This allows the medical/dental office to distinguish themselves through customized referral forms including logos, slogans, services provided, etc.

Further embodiments of the embodied medical/dental patient treatment management system relate to the technical advantage of going “Digital” and “Green” at the same time. Digital and EHR's (Electronic Health Records) are quickly becoming the standard in the medical and dental industries. The embodied medical/dental patient treatment management system helps achieve the goal of becoming a paperless, digital practice while “Going Green” at the same time.

Since all submissions are done directly through the embodied medical/dental patient treatment management system, edits and updates to all cases are made instantly and precisely—no more legibility issues or missing information. Multiple attending doctors as well as dental labs can view the referral information simultaneously so each participant is literally on the same page when reviewing patient profiles and prognosis.

Additional beneficial features for the medical and dental professionals using the embodied medical/dental patient treatment management system include an increase in practice visibility and patient/treatment management efficiency. The features of the embodied medical/dental patient treatment management system may help increase production through the system's more detailed and streamlined referral documentation; and the system's data reporting which allows in-depth tracking of referral origination, frequencies, treatment timelines and other relevant medical/dental practice management information.

Additionally, a healthcare professional may grow their referring doctor base by making their information visible to referring doctors in the community by adding their information to the embodied medical/dental patient treatment management system directory. Thus, when a referring physician/dentist generates a patient referral in the system, he or she is given the option to view all available treating specialists, etc. in the area so as to provide the best treatment option possible to the patient. Registered healthcare providers will also eliminate needless operating expenses created from multiple phone calls, chasing down illegible and poor quality forms, and lost emails and faxes which are available on the medical/dental patient treatment management system. Furthermore, the probability of legibility issues or missing information is greatly decreased. Generally the above features present in embodied medical/dental patient treatment management system improve the patient experience by allowing the medical professional to have what they need, when they need it; and all in one centralized location.

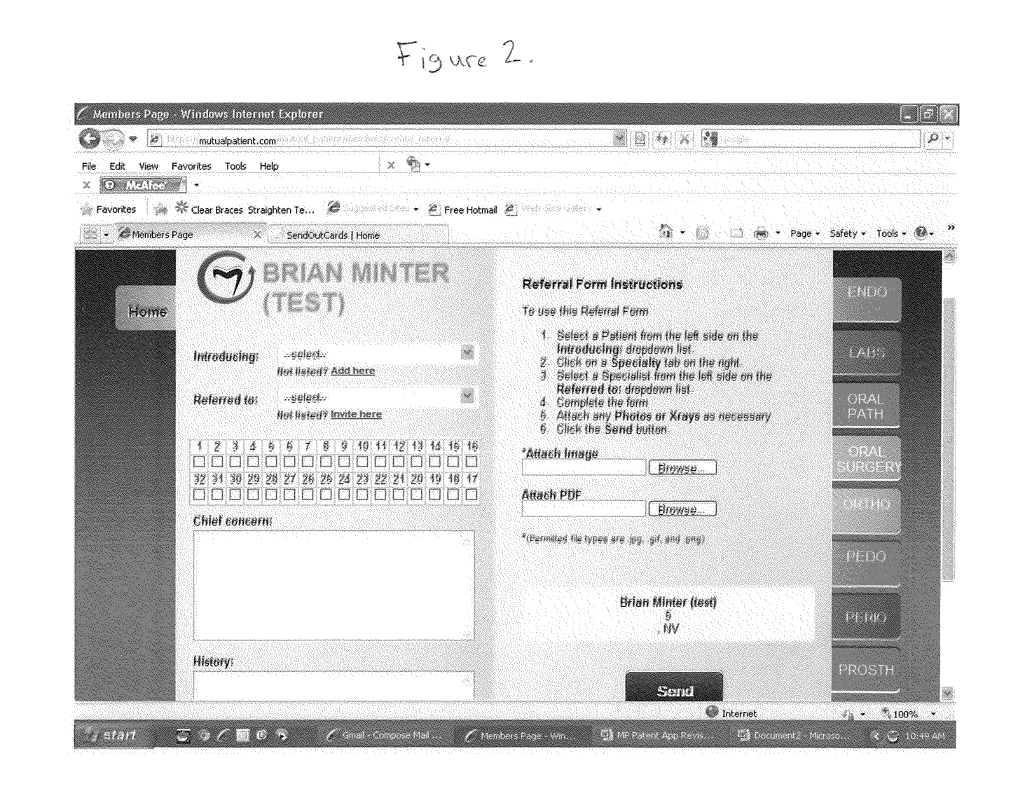

Additional embodiments of the present invention relate to the ability to track the medical professionals' progress with an embodied medical/dental patient treatment management system utilizing detailed reporting and analysis features integrated into the management system. These features may include the ability to monitor referrals on a regular basis, using a feature of the management system referred to as the DirectRefer reporting system (Shown in FIG. 2). Whether a generalist or specialist doctor or dentist, regularly tracking patient referrals is critical to the success and growth of a medical/dental practice. Thus the DirectRefer reporting features may track and summarize any combination of the following: a) How many referrals have been sent/received in a given period? b) What were the medical professionals case acceptance rates for that period? c) Who are your most frequent referring doctors? d) Who did the medical professional refer their patients to most often? e) What procedures are most commonly referred to/from said medical professionals practice?

Additional embodiments of the present invention may be added to provide a seamless communication across attending doctors thus improving productivity. For most dental practices today, the cross-functional treatment process involves multiple e-mails, hard copy referral slips and endless phone calls to locate missing information. The result is often missing information, miscommunication across treating doctors, and constant distractions to an already busy practice staff. Further embodiments of the present invention eliminate each of these issues by consolidating all necessary treatment information and putting it into one easy-to-access location. Whether a registered medical/dental user is referring a patient for an orthodontic consultation or updating a referring doctor on an advanced implant case with numerous X-rays and in-depth documentation, the registered medical/dental user controls exactly what information is shared and with whom.

Yet additional embodiments of the present invention provide for a secure, centralized location for all patient referrals wherein the privacy of both participating doctors and patients is a primary focus of an embodied patient management referral system. All uploaded information is protected using a secure, certificated SSL encryption system ensuring 100% privacy; all in accordance with HIPAA standards.

Additional embodiments comprise in addition to the encryption certificate, each account is password protected and the identity of all participating doctors is verified prior to being granted access to a Mutual Patient information management system. Confidentiality is a top priority—only those professionals chosen to share information with are granted access to their patient's account. Each registrant is also required to review and sign a privacy practices acknowledgment form.

The following examples are intended to illustrate but not limit the invention.

### EXAMPLE 1

Dental Mutual Patient Example

This example illustrates an exemplary step-by-step review of an embodied process contemplated in the system:

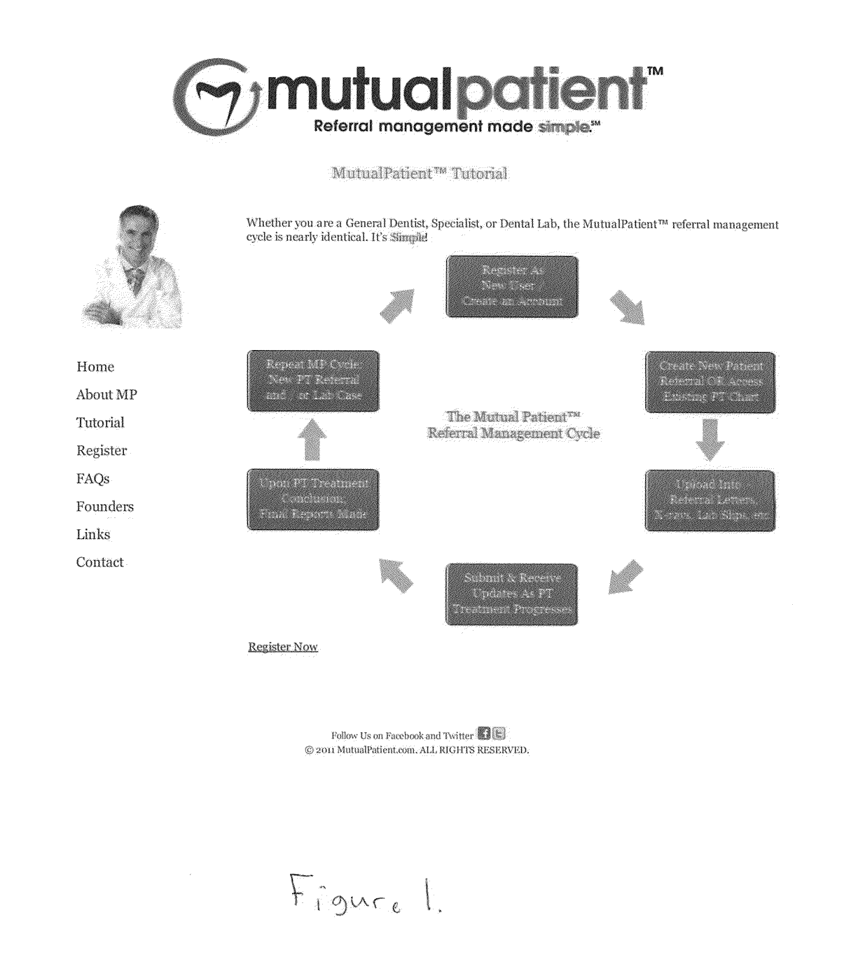

First FIG. 1 illustrates the tutorial page for the exemplary mutualpatient.com website which is an example of an embodied medical/dental patient treatment management system contemplated in the present invention. FIG. 1 shows the elements of the referral management cycle including the following steps:

First, a general dentist, specialist or dental lab would register as a new user and create an account on the website; Next they would create a New Patient Referral OR Access an existing Patients information; then upload information such as referral letters, X-rays, lab-slips, etc . . . : submit and receive updates as the patient treatment progresses; and upon patient treatment conclusion they would review a final report; and then report the cycle with a new patient or lab case.

When used in practice the following steps occur:

1) Patient is seen by a general dentist, who after a comprehensive exam, determines whether a referral to a specialist or a second dentist for further consult is needed.

2) A referral slip template to be accessed by the appropriate specialist is available on the MutualPatient website. The referring doctor's office creates an account for the patient online, completing the referral template and uploading it into the patient's new account, along with any x-rays (panoramic, FMX, etc.) or additional information that will be needed by the specialist.

3) An email is automatically generated and forwarded to the selected specialist office, informing them that:

“You have just been referred a patient to your office by Dr. Ilien Minter at Gateway Dentistry. An account for this patient has been created on the MutualPatient website.”

“For more information, please visit: www.MutualPatient.com”

User name: mutpat; Password: 123456; Patient Name: Brian Minter; ID #: BM12345 (The same password will grant access to all pending and prior patients for that particular specialist's office.). User IDs and system passwords are sent in SEPARATE emails.

Once these steps have been completed:

1) Both specialist and general dentist can now track and upload patient treatment information as necessary. Real time, simultaneous access will provide additional convenience between all offices.

2) Any time a change or update is made to patient information by either doctor or specialist office, an email is sent out to all attending doctors (including the user who just made the update).

Exemplary Email: An update has recently been made to the patient account of BRIAN MINTER—(ID #BM50021) who was referred to your office for ENDODONTIC TREATMENT on Mar. 12, 2011 by DR. ILIEN MINTER. Please visit the MutualPatient® website at www.MutualPatient.com for more information.

Upon entering the Mutual Patient website the medical professional (in this example, an Endodontist) would see the following message: “Welcome to MutualPatient—a centralized, collaborative platform that allows doctors to jointly manage patient treatment in a real-time, user-friendly format. In some embodiments created for the dental industry, MutualPatient provides the following for each individual medical or dental team:

A Real time, Multi-User Interface—Access treatment updates, progress notes, X-rays, referral letters and more. Manage patient cases remotely and in real time, while on travel or away from the office.

Technical Advantage—Share digital imaging and case information with all attending doctors—even the dental lab—to thoroughly oversee the patient treatment management process from beginning to end.

Increase Patient Referrals by making your practice information available to other referring doctors in your area.

Detailed Reportin & Analysis—Detailed analysis on referring doctors, case acceptance statistics, treatment timelines, and more.

Improved Productivity—End missing and incomplete treatment information, using a simple, user-friendly submission process.

Once the medical professional (in this case, an endodontist) subscribes on the website the treatment collaboration is made simple through the use of real time, multi-user access to all treatment documentation. The endodontist (in this case) is thus able to instantly access, review, and update all patient treatment information provided by referring medical/dental personnel and provide edits and updates of patient treatment under their care. All patient treatment updates are accessible immediately, in real time. Additionally, e-mail notices are automatically sent to inform all attending doctors once any changes are made, treatment performed, or updates made to your patient's case. Additionally, with a multi-user interface two or more attending physicians/dentists/laboratories, etc. can view patient information simultaneously and can simply call their colleague(s), reference the patient chart in MutualPatient™, and all parties may review and coordinate patient care accordingly.

Although the invention has been described with reference to the above example, it will be understood that modifications and variations are encompassed within the spirit and scope of the invention. Accordingly, the invention is limited only by the following claims.

What is claimed is:

1. A web-based patient treatment and referral management system comprising a centralized, collaborative platform that allows dentists, doctors, healthcare assistants and professionals to jointly manage patient treatment in a real-time multi-user interface;
wherein the web-based patient treatment and referral management system is used by a medical professional or their staff to access a patients treatment updates, progress notes, X-rays, and referral letters;
wherein the web-based patient treatment and referral management system is used by the medical professional or their staff to manage patient cases remotely and in real time, while on travel or away from the office;
wherein the web-based patient treatment and referral management system is used by the medical professional or their staff to share digital imaging and case information with all attending doctors or independent labs and thus is able to thoroughly oversee the patient treatment management process from beginning to end.

2. The web-based patient treatment and referral management system of claim 1, wherein the system is used to coordinate dental care and records for a jointly managed patient.

3. The web-based patient treatment system of claim 1, wherein two or more attending physicians, dentists, laboratories, or treatment specialists can view patient information simultaneously and can simply call their colleague(s), reference the patient chart in the patient treatment system, and all parties may review and coordinate patient care accordingly.

4. The web-based patient treatment system of claim 1, wherein e-mail notices are automatically sent to inform all attending doctors once any changes in the patient records are made, treatment performed, or updates made to the patient's case.

5. The web-based patient treatment system of claim 1, further comprising a detailed analysis on referring doctors, case acceptance statistics, and treatment timelines.

6. The web-based patient treatment system of claim 1, further comprising a referral slip template to be accessed by an appropriate specialist; wherein a referring doctor's office creates an account for the patient online, completing the referral template and uploading it into the patient's new account, along with any x-rays (panoramic, FMX, etc.) or additional information that will be needed by the specialist.

7. The web-based patient treatment system of claim 6, further wherein an email is automatically generated and forwarded to the selected specialist office, informing them that they have just been referred a patient to their office by a referring physiciena and that an account for this patient has been created on the system website.
